(19) United States
(12) Patent Application Publication
(10) Pub. No.: US 2022/0045325 A1
(43) Pub. Date: Feb. 10, 2022

(54) POSITIVE ELECTRODE MATERIAL, ELECTROCHEMICAL DEVICE CONTAINING SAME, AND ELECTRONIC DEVICE

(71) Applicant: Dongguan Poweramp Technology Limited, Dongguan City (CN)

(72) Inventor: Xin Jiang, Dongguan City (CN)

(73) Assignee: Dongguan Poweramp Technology Limited, Dongguan City (CN)

(21) Appl. No.: 17/394,542

(22) Filed: Aug. 5, 2021

(30) Foreign Application Priority Data
Aug. 6, 2020 (CN) 202010784966.4

(51) Int. Cl. H01M 4/58; H01M 4/62; H01M 4/525; H01M 4/505; H01M 4/36; H01M 10/0525

(52) U.S. Cl. CPC H01M 4/58; H01M 4/625; H01M 4/525; H01M 2004/028; H01M 4/366; H01M 10/0525; H01M 4/505

(57) ABSTRACT

A positive electrode material includes a substrate material, a one-dimensional conductive agent, and a fast ion conductor. The one-dimensional conductive agent exists on a surface of the substrate material, and the fast ion conductor exists on a surface of the one-dimensional conductive agent. The positive electrode material has improved electronic conductivity and ionic conductivity, thereby improving the performance of the electrochemical device containing the positive electrode material and of the electronic device.

### CROSS-REFERENCE TO RELATED APPLICATIONS

This application claims priority to Chinese Patent Application No. 202010784966.4, filed on Aug. 6, 2020, the whole disclosure of which is incorporated herein by reference.

### TECHNICAL FIELD

This application relates to the field of electrochemical technology, and in particular, to a positive electrode material, an electrochemical device containing the positive electrode material, and an electronic device.

### BACKGROUND

A lithium-ion battery is characterized by a high specific energy, a high operating voltage, a low self-discharge rate, a small size, a light weight, and the like, and is widely used in various fields such as electrical energy storage and power supplies of portable electronic devices and electric vehicles.

With rapid development of electric vehicles and portable electronic devices, people are posing higher requirements on relevant features such as an energy density, safety, cycle performance of the lithium-ion battery. A positive electrode material in the lithium-ion battery urgently needs to be improved to enhance the cycle performance and electrochemical stability of existing lithium-ion batteries.

### SUMMARY

An objective of this application is to provide a positive electrode material, an electrochemical device containing the positive electrode material, and an electronic device to further improve electronic conductivity and ionic conductivity of the positive electrode material and thereby improve the performance of the electrochemical device. Specific technical solutions are as follows:

A first aspect of this application provides a positive electrode material, including a substrate material, a one-dimensional conductive agent, and a fast ion conductor.

The one-dimensional conductive agent exists on a surface of the substrate material, and the fast ion conductor exists on a surface of the one-dimensional conductive agent.

In an implementation solution of this application, the one-dimensional conductive agent includes at least one of carbon nanotubes or carbon fiber.

In an implementation solution of this application, the fast ion conductor includes a compound LiₓLa_{y}Zr_{z}MₐO_{b}, where 6≤x≤8, 2≤y≤4, 1≤z≤3, 0≤a≤0.5, 11≤b≤13, the M element is at least one selected from a Ta element or a W element.

In an implementation solution of this application, the fast ion conductor includes at least one of Li₇La₃Zr₂O₁₂ or Li₁₀GeP₂S₁₂.

In an implementation solution of this application, an ionic conductivity of the fast ion conductor is 1×10⁻⁴ S/cm to 2.7×10⁻² S/cm.

In an implementation solution of this application, the substrate material includes at least one of lithium manganese iron phosphate, lithium iron phosphate, lithium nickel cobalt manganate, lithium nickel cobalt aluminate, lithium manganate, or lithium cobaltate.

In an implementation solution of this application, a molar ratio of a manganese element to an iron element in the lithium manganese iron phosphate is 0.01 to 10.

In an implementation solution of this application, based on a total mass of the positive electrode material, a weight percent of the one-dimensional conductive agent is 0.05% to 5%, and a weight percent of the fast ion conductor is 0.05% to 5%.

In an implementation solution of this application, a mass ratio of the one-dimensional conductive agent to the fast ion conductor is 0.1:1 to 10:1.

In an implementation solution of this application, a length-to-diameter ratio of the one-dimensional conductive agent is 100 to 6250.

In an implementation solution of this application, a length of the one-dimensional conductive agent is 300 nm to 50,000 nm, and a diameter of the one-dimensional conductive agent is 8 nm to 50 nm.

In an implementation solution of this application, a specific surface area of the carbon nanotubes is 25 g/m² to 300 g/m².

In an implementation solution of this application, the carbon nanotubes include at least one of single-walled carbon nanotubes or multi-walled carbon nanotubes.

In an implementation solution of this application, the substrate material includes at least one of ZrO₂, SnO₂, ZnO, MgO, Al₂O₃, TiO₂, CeO₂, AlF₃, or Li₃AlF₆.

A second aspect of this application provides an electrochemical device, including a positive electrode plate, a negative electrode plate, and a separator. The separator is located between the positive electrode plate and the negative electrode plate. The positive electrode plate includes a positive active material layer. The positive active material layer includes the positive electrode material according to the first aspect.

In an implementation solution of this application, a resistance of the positive active material layer is 0.1 mΩ to 50 mΩ.

A third aspect of this application provides an electronic device, including the electrochemical device according to the second aspect.

This application provides a positive electrode material, an electrochemical device containing the positive electrode material, and an electronic device. The one-dimensional conductive agent exists on the surface of the substrate material, and the fast ion conductor exists on the surface of the one-dimensional conductive agent. The one-dimensional conductive agent contains a one-dimensional channel, and can be in point-line contact with the substrate material, thereby forming a sounder conductive network and improving the electronic conductivity of the positive electrode material. The one-dimensional conductive agent can provide a lot of attachment sites for the fast ion conductors, so that a larger quantity of fast ion conductors exist on the surface of the one-dimensional conductive agent. The fast ion conductors are characterized by a wide electrochemical window, stable properties, and a high ion conductivity, thereby improving the ionic conductivity of the positive electrode material and improving cycle performance and electrochemical stability of the electrochemical device (such as a lithium-ion battery).

### BRIEF DESCRIPTION OF DRAWINGS

To describe the technical solutions in this application more clearly, the following outlines the drawings to be used in the embodiments of this application. Evidently, the drawings outlined below are merely about some embodiments of this application, and a person of ordinary skill in the art may derive other technical solutions from the drawings.

FIG. 1 is a scanning electron microscope (SEM) image of a positive electrode material according to Embodiment 1 of this application; and

FIG. 2 is a schematic diagram of a cycle test result of a lithium-ion battery according to Embodiment 1 and Comparative Embodiment 1 of this application.

### DETAILED DESCRIPTION OF EMBODIMENTS

To make the objectives, technical solutions, and advantages of this application clearer, the following describes this application in further detail with reference to drawings and embodiments. It is apparent that the described embodiments are merely a part of but not all of the embodiments of this application.

It needs to be noted that in specific embodiments of this application, this application is construed by using a lithium-ion battery as an example of the electrochemical device, but the electrochemical device according to this application is not limited to the lithium-ion battery.

As a new type of positive active material, a lithium manganese iron phosphate material possesses a higher voltage platform than a lithium iron phosphate material despite an identical theoretical specific capacity of 170 mAh/g, and thereby achieves a higher energy density. In addition, the lithium manganese iron phosphate material possesses the same olivine structure as the lithium iron phosphate and achieves high safety performance. However, an electronic conductivity and an ionic conductivity of the lithium manganese iron phosphate material are low, resulting in a low lithium ion transfer speed. Consequently, electrochemical activity of the positive electrode material that uses the lithium manganese iron phosphate material is relatively low. Although the existing lithium manganese iron phosphate as a positive electrode material increases electronic conductivity, but achieves a limited increase in ionic conductivity. The cycle performance of a lithium-ion battery made from the existing lithium manganese iron phosphate as a positive electrode material is still low. Especially, the capacity of the battery attenuates significantly after high-rate cycling. In addition, if the substrate material is coated with merely a conductive agent, dissolution of metal (such as Mn) out of the positive material is not suppressed. Metal ions are deposited on a negative electrode. Consequently, a solid electrolyte interface (SEI) film keeps regenerating and consumes active lithium in the lithium-ion battery, thereby attenuating the capacity of the lithium-ion battery rapidly.

In view of this, this application provides a positive electrode material. The positive electrode material includes a substrate material, a one-dimensional conductive agent, and a fast ion conductor. The one-dimensional conductive agent exists on a surface of the substrate material, and the fast ion conductor exists on a surface of the one-dimensional conductive agent.

A one-dimensional conductive agent exists on the surface of the substrate material in the positive electrode material according to this application, and a fast ion conductor exists on the surface of the one-dimensional conductive agent. Evidently, through the structure of the positive electrode material in this application, the one-dimensional conductive agent can be in a point-line contact with the substrate material, and particles are connected by the one-dimensional conductive agent, so as to form a sound conductive network. In addition, the one-dimensional conductive agent possesses a relatively high length-to-diameter ratio, and can provide relatively many attachment sites for the fast ion conductors, so that the fast ion conductors exist on the surface of the one-dimensional conductive agent. On the one hand, this improves the structural stability of the positive electrode material, and on the other hand, this improves the ionic conductivity and the electronic conductivity of the positive electrode material in this application.

The positive electrode material in this application is applicable in a positive electrode plate to improve the ionic conductivity and the electronic conductivity of the positive electrode plate, so as to improve the performance such as cycle performance of the lithium-ion battery that uses the positive electrode material in this application.

This application imposes no special limitation on the one-dimensional conductive agent as long as the one-dimensional conductive agent achieves the objective of this application. For example, the one-dimensional conductive agent may include at least one of carbon nanotubes (CNT) or carbon fiber.

In an implementation solution of this application, the fast ion conductor may further include an M element-doped fast ion conductor. The M element is at least one selected from a Ta element or a W element. The doping with the M element further increases the ion conductivity of the fast ion conductor. On the one hand, the fast ion conductor possesses a high ionic conductivity, and is attached onto the one-dimensional conductive agent, mixed between particles of the substrate material, and in contact with the particles of the substrate material, and serves to conduct ions and electrons and improve both the electronic conductivity and the ionic conductivity of the positive electrode material. On the other hand, an operating potential of Mn³⁺ and Mn²⁺ in the lithium manganese iron phosphate (LMFP) is approximately 4.0 V. Under a relatively high voltage condition, both thermal stability and electrochemical stability of a lithium manganese iron phosphate battery are poor, thereby affecting the electrochemical performance and the safety performance of the battery. For example, due to the John-Teller effect of manganese, manganese dissolution leads to a short circuit of the lithium-ion battery, a reaction between a positive electrode and an electrolytic solution leads to gassing, and the like. By contrast, the fast ion conductor is structurally steady, and exists around the particles of the substrate material by bridging with the one-dimensional conductive agent. This improves mechanical performance of the positive electrode material and stabilizes a crystal structure of the surface of the particles of the substrate material, improves overall structural stability of the positive electrode material, and suppresses the manganese dissolution out of the positive electrode material, thereby reducing the problems such as short circuit and gassing caused by the manganese dissolution in the lithium-ion battery and improving the electrochemical performance of the lithium-ion battery.

In addition, this application does not impose any special limitation on the doping amount of the M element as long as the doping can achieve the objective of this application. For example, the M element-doped fast ion conductor may be Ta-doped LiₓLa_{y}Zr_{z}MₐO_{b}, where 6≤x≤8, 2≤y≤4, 1≤z≤3, 0≤a≤0.5, 11≤b≤13. The doping amount of the Ta element is 0.01 mole to 0.5 mole, which means that each mole of LiₓLa_{y}Zr_{z}MₐO_{b} contains 0.01 mole to 0.5 mole of Ta element. Specifically, the fast ion conductor may be Li₇La₃Zr₂O₁₂ doped with 0.3 mole of Ta element.

In an implementation solution of this application, the fast ion conductor may include at least one of Li₇La₃Zr₂O₁₂ (LLZO) or Li₁₀GeP₂S₁₂ (LGPS).

The ionic conductivity of the fast ion conductor according to this application is 1×10⁻⁴ S/cm to 2.7×10⁻² S/cm, thereby increasing the ionic conductivity of the positive electrode material and improving the performance of the lithium-ion battery.

The substrate material according to this application may contain a material with an olivine structure, such as lithium manganese iron phosphate (LiMn₁₋ₓFeₓPO₄, LMFP for short), lithium iron phosphate (LiFePO₄, LFP for short), or lithium manganese phosphate (LiMnPO₄). Such materials are of high safety and a high energy density. Further, the substrate material may contain other materials, for example, at least one of ternary materials such as lithium nickel cobalt manganate and lithium nickel cobalt aluminate (specifically, including NCM811, NCM622, NCM523, or NCM333), and at least one of spinel-structured materials such as lithium cobaltate or lithium manganate.

In an implementation solution of this application, the molar ratio of the manganese element to the iron element in the lithium manganese iron phosphate is 0.01 to 10. The energy density of a lithium iron phosphate battery is lower than that of a lithium manganese phosphate battery, and a lithium manganese iron phosphate battery goes between the lithium iron phosphate battery and the lithium manganese phosphate battery. However, the electrical conductivity of lithium manganese phosphate is lower than that of lithium iron phosphate. In order to increase the energy density of the battery and increase the electrical conductivity of the positive electrode material, the molar ratio of manganese to iron is controlled to be foregoing value.

In an implementation solution of this application, based on a total mass of the positive electrode material, a weight percent of the one-dimensional conductive agent is 0.05% to 5%, and optionally 0.2% to 3%; a weight percent of the fast ion conductor is 0.05% to 5%, and optionally, 0.2% to 3%. The rest is the substrate material. In this way, the positive electrode material achieves high structural stability, electronic conductivity, and ionic conductivity.

In an implementation solution of this application, a mass ratio of the one-dimensional conductive agent to the fast ion conductor is 0.1:1 to 10:1, and optionally 0.2:1 to 5:1. Without being limited by any theory, when the mass ratio of the one-dimensional conductive agent to the fast ion conductor is too high, the quantity of fast ion conductors is relatively small, and no sufficient fast ion conductors are attached onto the one-dimensional conductive agent, thereby being adverse to improving the structural stability of the positive electrode material. When the mass ratio of the one-dimensional conductive agent to the fast ion conductor is too low, the quantity of one-dimensional conductive agent is relatively small, the quantity of fast ion conductors that are not attached onto the surface of the one-dimensional conductive agent increases, and the percentage of the substrate material in the positive electrode material decreases, thereby affecting the energy density of the lithium-ion battery. By controlling the mass ratio of the one-dimensional conductive agent to the fast ion conductor to be within the foregoing range, the positive electrode material achieves high structural stability, high electronic conductivity, and high ionic conductivity.

In an implementation solution of this application, a length-to-diameter ratio of the one-dimensional conductive agent is 100 to 6250. By controlling the length-to-diameter ratio to be within the foregoing range, the solution of this application provides more attachment sites for the fast ion conductors, and more fast ion conductors are attached onto the surface of the one-dimensional conductive agent, thereby further improving the ionic conductivity of the material.

In an implementation solution of this application, a length of the one-dimensional conductive agent is 300 mn to 50,000 nm, and optionally, 1000 nm to 30,000 nm, and more optionally, 1000 nm to 10,000 nm; and a diameter (outer diameter) of the one-dimensional conductive agent is 8 nm to 50 nm. By controlling the length and diameter of the one-dimensional conductive agent to be within the foregoing range, the positive electrode material according to this application achieves a higher electronic conductivity.

In an implementation solution of this application, a specific surface area of the carbon nanotubes is 25 g/m² to 300 g/m². A relatively large specific surface area can provide more attachment sites for the fast ion conductors, thereby increasing the ionic conductivity of the positive electrode material.

This application imposes no special limitation on the carbon nanotubes as long as the carbon nanotubes achieve the objective of this application. For example, the carbon nanotubes include single-walled carbon nanotube or multi-walled carbon nanotubes.

In an implementation solution of this application, at least one of ZrO₂, SnO₂, ZnO, MgO, Al₂O₃, TiO₂, CeO₂, AlF₃, or Li₃AlF₆ may be contained on a superficial layer of the substrate material. Without being limited to any theory, the structural stability of the substrate material is enhanced due to the stability of the foregoing oxides or fluorides. Certainly, the oxides or fluorides may exist on at least a part of the superficial layer of the substrate material, or on all of the superficial layer. In this application, the content of the oxides or fluorides is not particularly limited. For example, based on the total mass of the substrate material, the weight percent of the oxides or fluorides is 0.1% to 3%.

The negative electrode plate in this application is not particularly limited as long as the negative electrode plate can achieve the objective of this application. For example, the negative electrode plate generally includes a negative current collector and a negative active material layer. The negative current collector is not particularly limited, and may be any negative current collector known in the art, for example, a copper foil, an aluminum foil, an aluminum alloy foil, or a composite current collector. The negative active material layer includes a negative active material. The negative active material is not particularly limited, and may be any negative active material known in the art. For example, the negative active material layer may include at least one of artificial graphite, natural graphite, mesocarbon microbead, soft carbon, hard carbon, silicon, silicon carbon, lithium titanate, or the like.

The separator in this application includes, but is not limited to, at least one of polyethylene, polypropylene, polyethylene terephthalate, polyimide, and aramid. For example, the polyethylene includes a component selected from at least one of high-density polyethylene, low-density polyethylene, and ultra-high-molecular-weight polyethylene. Especially the polyethylene and the polypropylene are highly effective in preventing short circuits, and improve stability of the lithium-ion battery through a shutdown effect.

A porous layer may be further disposed on a surface of the separator. The porous layer is disposed on at least one surface of the separator. The porous layer includes inorganic particles and a binder. The inorganic particles are one or more selected from aluminum oxide (Al₂O₃), silicon oxide (SiO₂), magnesium oxide (MgO), titanium oxide (TiO₂), hafnium dioxide (HFO₂), tin oxide (SnO₂), ceria (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide, or barium sulfate. The binder is one or more selected from polyvinylidene fluoride, vinylidene fluoride-hexafluoropropylene copolymer, polyamide, polyacrylonitrile, polyacrylate, polyacrylic acid, polyacrylate, sodium carboxymethyl cellulose, polyvinylpyrrolidone, polyvinyl ether, poly methyl methacrylate, polytetrafluoroethylene, and polyhexafluoropropylene.

The porous layer can improve heat resistance and oxidation resistance of the separator, and infiltration performance of the electrolytic solution, and enhance adhesivity between the separator and the positive electrode or negative electrode.

The battery according to this application further includes an electrolyte. The electrolyte may be one or more of a gel electrolyte, a solid-state electrolyte, and an electrolytic solution. The electrolytic solution includes a lithium salt and a nonaqueous solvent.

In some embodiments of this application, the lithium salt is one or more selected from LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, and lithium difluoroborate. For example, the lithium salt is LiPF₆ because it provides a high ionic conductivity and improves cycle characteristics.

The nonaqueous solvent may be a carbonate compound, a carboxylate compound, an ether compound, another organic solvent, or any combination thereof.

The carbonate compound may be a chain carbonate compound, a cyclic carbonate compound, a fluorocarbonate compound, or any combination thereof.

Examples of the chain carbonate compound are dimethyl carbonate (DMC), diethyl carbonate (DEC), dipropyl carbonate (DPC), methyl propyl carbonate (MPC), ethylene propyl carbonate (EPC), ethyl methyl carbonate (EMC), or any combinations thereof. Examples of the cyclic carbonate compound are ethylene carbonate (EC), propylene carbonate (PC), butylene carbonate (BC), vinyl ethylene carbonate (VEC), or any combination thereof. Examples of the fluorocarbonate compound are fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, trifluoromethyl ethylene carbonate, or any combinations thereof.

Examples of the carboxylate compound are methyl formate, methyl acetate, ethyl acetate, n-propyl acetate, tert-butyl acetate, methyl propionate, ethyl propionate, propyl propionate, γ-butyrolactone, decanolactone, valerolactone, mevalonolactone, caprolactone, or any combinations thereof.

Examples of the ether compound are dibutyl ether, tetraglyme, diglyme, 1,2-dimethoxyethane, 1,2-diethoxyethane, ethoxy-methoxyethane, 2-methyltetrahydrofuran, tetrahydrofuran, or any combination thereof.

Examples of the other organic solvent are dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester, and any combination thereof.

This application further provides a positive electrode plate. The positive electrode plate includes a positive active material layer. The positive active material layer includes the positive electrode material described in any of the foregoing implementation solutions. Because the positive electrode material is of high structural stability, high electronic conductivity, and high ionic conductivity, the positive electrode plate according to this application is also of high structural stability, high electronic conductivity, and high ionic conductivity. The resistance of the positive active material layer according to this application is 0.1 mΩ to 50 mΩ. A test method of the resistance of the positive active material layer will be described below.

This application fluffier provides an electrode assembly, including a positive electrode plate, a negative electrode plate, and a separator. The separator is located between the positive electrode plate and the negative electrode plate. The electrode assembly includes the positive electrode plate described in the foregoing implementation solution.

This application further provides an electrochemical device. The electrochemical device includes an electrolytic solution and the electrode assembly described in the foregoing implementation solution, and achieves high cycle performance and high capacity retention performance.

This application further provides an electronic device. The electronic device includes the electrochemical device described in any of the implementation solutions of this application, and achieves a longer service life and higher safety.

The electronic device according to this application is not particularly limited, and may be any electronic device known in the prior art. In some embodiments, the electronic device may include, but is not limited to, a notebook computer, a pen-inputting computer, a mobile computer, an e-book player, a portable phone, a portable fax machine, a portable photocopier, a portable printer, a stereo headset, a video recorder, a liquid crystal display television set, a handheld cleaner, a portable CD player, a mini CD-ROM, a transceiver, an electronic notepad, a calculator, a memory card, a portable voice recorder, a radio, a backup power supply, a motor, a car, a motorcycle, a power-assisted bicycle, a bicycle, a lighting appliance, a toy, a game machine, a watch, an electric tool, a flashlight, a camera, a large household battery, a lithium-ion capacitor, and the like.

The preparation process of the electrochemical device is well known to a person skilled in the art, and is not particularly limited in this application. For example, a process of manufacturing a lithium-ion battery may include: stacking a positive electrode and a negative electrode that are separated by a separator, performing operations such as winding and folding as required, placing them into a housing, injecting an electrolytic solution into the housing, and sealing the housing, where the negative electrode in use is the negative electrode plate provided in this application. In addition, an overcurrent prevention element, a guide plate, and the like may be further placed into the housing as required, so as to prevent the rise of internal pressure, overcharge, and overdischarge of the lithium-ion battery.

This application imposes no particular limitation on the preparation method of the positive electrode material. For example, the positive electrode material may be prepared according to the following method:

Steps of preparing a first suspension:

Grinding a one-dimensional conductive agent and a fast ion conductor separately, passing them through a 300- to 600-mesh sieve, and dispersing the sieved one-dimensional conductive agent and the sieved fast ion conductor into an organic solvent at a mass ratio of 0.1:1 to 10:1 to obtain a first suspension with a solid content of 35% to 65%.

Steps of preparing a second suspension:

Grinding a substrate material, passing it through a 300- to 600-mesh sieve, and dispersing the sieved substrate material into an organic solvent to obtain a second suspension with a solid content of 35% to 65%.

Steps of mixing the suspensions:

Mixing the first suspension and the second suspension evenly to obtain a mixed slurry with a solid content of 40% to 60%, and spray-drying the mixed slurry to obtain a positive electrode material precursor. Based on a total mass of the substrate material, the one-dimensional conductive agent, and the fast ion conductor, the weight percent of the one-dimensional conductive agent is 0.05% to 5%, the weight percent of the fast ion conductor is 0.05% to 5%, and the rest is the substrate material.

Roasting steps:

Roasting the positive electrode material precursor in an inert gas at a temperature of 300° C. to 800° C. for a duration of 6 to 24 hours. If the roasting temperature is too low, the one-dimensional conductive agent and the fast ion conductor are distributed unevenly, and the performance of the lithium-ion battery is not improved significantly. If the roasting temperature is too high, the material is likely to be excessively roasted, the stability of the material will decrease, and the performance and safety of the lithium-ion battery will be affected. If the roasting duration is too short, the one-dimensional conductive agent and the fast ion conductor are distributed unevenly, and the performance of the lithium-ion battery is not improved significantly. If the roasting duration is too long, the stability of the material will decrease, and the cycle performance and the capacity of the lithium-ion battery will be affected.

This application imposes no special limitation on the solid content of the first suspension and the second suspension as long as the objective of this application can be achieved. For example, the solid content of the first suspension may be 35% to 65%, and the solid content of the second suspension may be 35% to 65%, but not too low. A too low solid content makes it difficult to implement the subsequent spray-drying process. In addition, as long as the weight percent of the one-dimensional conductive agent in the positive electrode material is 0.05% to 5% and the weight percent of the fast ion conductor in the positive electrode material is 0.05% to 5% after mixing, this application imposes no special limitation on the solid content of the mixed slurry. For example, the solid content of the mixed slurry is 40% to 60%.

This application imposes no specifical limitation on the organic solvent used to disperse the one-dimensional conductive agent, the fast ion conductor, and the substrate material as long as the organic solvent meets the requirements of this application. For example, the organic solvent may include at least one of ethanol or methanol.

This application imposes no special limitation on the roasting atmosphere. For example, the roasting atmosphere may be at least one selected from argon, helium, neon, or nitrogen. That is because the composition or structure of the positive electrode material may change to different extents under a high temperature when the positive electrode material is roasted in air. This destroys the particle structure of the positive electrode material, and affects the stability of the material. An inert gas environment can avoid such a situation and is conducive to structural stability of the positive electrode material.

This application imposes no special limitation on the spray-drying process as long as the objective of this application is achieved. For example, centrifugal spray-drying may be performed at a centrifugal rotation speed of 500 rpm to 5000 rpm.

In the preparation method according to this application, in the positive electrode material precursor obtained by spray-drying. the fast ion conductor can be attached onto the surface of the one-dimensional conductive agent. The one-dimensional conductive agent on which the fast ion conductor is attached is mixed between the particles of the substrate material, and then subjected to a subsequent high-temperature roasting process. In this way, the one-dimensional conductive agent on which the fast ion conductor is attached is formed between the particles of the substrate material and in contact with the particles of the substrate material, so as to serve a function of conducting ions and electrons and obtain a positive electrode material with a high ionic conductivity and a high electronic conductivity. Compared with other positive electrode materials, the positive electrode material obtained according to the preparation method in this application enriches ion and electron transfer channels in the positive electrode material and creates an ion-electron hybrid conductive network on the one hand, and effectively reduces an interface resistance on the other hand. In addition, according to the preparation method in this application, positive electrode materials with different ingredient contents can be obtained by adjusting parameters such as a reaction temperature, the content of the one-dimensional conductive agent, and the content of the fast ion conductor. The preparation method is applicable to different types of working conditions. The conditions of the preparation method according to this application are easy to control, and the technical process is mature. The synthesized positive electrode material is of high ionic conductivity and high electronic conductivity, and possesses a steady particle structure, and can effectively improve the electrochemical performance of the lithium-ion battery.

The implementations of this application are described below in more detail with reference to embodiments and comparative embodiments. Various tests and evaluations are performed in accordance with the following methods. In addition, unless otherwise specified, “fraction” and “%” are a measure of mass.

### Embodiment 1

<Preparing a Positive Electrode Material<

<Preparing a First Suspension>

Grinding a one-dimensional conductive agent CNT and a fast ion conductor LLZO separately, passing them through a 400-mesh sieve, and dispersing the sieved CNT and the sieved LLZO into anhydrous ethanol at a mass ratio of 1:1 to obtain a first suspension with a solid content of 50%.

<Preparing a Second Suspension>

Grinding lithium manganese iron phosphate (LMFP) as a substrate material, passing it through a 400-mesh sieve, and dispersing the sieved LMFP into anhydrous ethanol to obtain a second suspension with a solid content of 50%. The molar ratio of manganese to iron in the LMFP is 6:4.

<Mixing the Suspensions>

Mixing the first suspension and the second suspension evenly to obtain a mixed slurry with a solid content of 50%, and spray-drying the mixed shiny to obtain a positive electrode material precursor. Based on a total mass of the substrate material, the one-dimensional conductive agent, and the fast ion conductor, the weight percent of the CNT is 1.5%, the weight percent of the LLZO is 1.5%, and the rest is the substrate material LMFP.

<Roasting>

Roasting the positive electrode material precursor in an argon atmosphere at a temperature of 600° C. for a duration of 15 hours.

The CNT is single-walled, with a length-to-diameter ratio of 1000, a length of 20,000 nm, a diameter of 20 nm, and a specific surface area of 42 g/m². The ion conductivity of the LLZO is 5×10⁻⁴ S/cm.

<Preparing a Positive Electrode Plate>

Mixing the prepared positive electrode material, acetylene black as a conductive agent, and polyvinylidene difluoride (PVDF) as a binder at a mass ratio of 95:3:2, adding N-methyl-pyrrolidone (NMP) as a solvent, blending the mixture into a shiny with a solid content of 75%, and stirring the slurry evenly. Coating one surface of a 12 μm thick aluminum foil with the slurry evenly, drying the slurry at a temperature of 90° C., performing cold calendering to obtain a positive electrode plate on which the thickness of the positive active material layer is 100 μm, and then repeating the foregoing steps on the other surface of the positive electrode plate to obtain a positive electrode plate coated with the positive active material layer on both sides. Cutting the positive electrode plate into a size of 74 mm×867 mm, welding tabs, and leaving the positive electrode plate ready for use.

<Preparing a Negative Electrode Plate>

Mixing artificial graphite as a negative active material, acetylene black as a conductive agent, styrene butadiene rubber (SBR) as a binder, and sodium carboxymethyl cellulose (CMC) as a thickener at a mass ratio of 95:2:2:1, and then adding deionized water as a solvent, blending the mixture into a slurry with a solid content of 70%, and stirring the slurry evenly; and coating one surface of a 10 μm thick copper foil with the slimy evenly, drying the copper foil at a temperature of 110° C., performing cold calendering to obtain a negative electrode plate coated with a 150 μm thick negative active material layer on a single side, and then repeating the foregoing coating steps on the other surface of the negative electrode plate to obtain a negative electrode plate coated with the negative active material layer on both sides. Cutting the negative electrode plate into a size of 74 mm×867 mm, welding tabs, and leaving the negative electrode plate ready for use.

<Preparing an Electrolytic Solution>

Mixing ethylene carbonate (EC), ethyl methyl carbonate (EMC), and diethyl carbonate (DEC) as organic solvents at a mass ratio of 30:50:20 in a dry argon atmosphere, adding lithium hexafluorophosphate (LiPF₆) into the organic solvents to dissolve, and stirring the mixture evenly to obtain an electrolytic solution in which a molar concentration of LiPF₆ is 1.15 mol/L.

<Preparing a Lithium-Ion Battery>

Using a 15 μm thick polyethylene (PE) porous film as a separator, sequentially stacking the positive electrode plate, the separator, and the negative electrode plate that are prepared above, leaving the separator to be located between the positive electrode plate and the negative electrode plate to serve a function of separation, and winding them to obtain an electrode assembly. Placing the electrode assembly into a housing, injecting the prepared electrolytic solution, and performing packaging; and performing steps such as chemical formation, degassing, and edge trimming to obtain a lithium-ion battery.

### Embodiment 2

This embodiment is the same as Embodiment 1 except that the weight percent of both the one-dimensional conductive agent and the fast ion conductor is 0.05%.

### Embodiment 3

This embodiment is the same as Embodiment 1 except that the weight percent of both the one-dimensional conductive agent and the fast ion conductor is 0.1%.

### Embodiment 4

This embodiment is the same as Embodiment 1 except that the weight percent of both the one-dimensional conductive agent and the fast ion conductor is 0.2%.

### Embodiment 5

This embodiment is the same as Embodiment 1 except that the weight percent of both the one-dimensional conductive agent and the fast ion conductor is 0.5%.

### Embodiment 6

This embodiment is the same as Embodiment 1 except that the weight percent of both the one-dimensional conductive agent and the fast ion conductor is 3%.

### Embodiment 7

This embodiment is the same as Embodiment 1 except that the weight percent of both the one-dimensional conductive agent and the fast ion conductor is 5%.

### Embodiment 8

This embodiment is the same as Embodiment 1 except that the weight percent of the one-dimensional conductive agent is 0.15%, the weight percent of the fast ion conductor is 1.5%, that is, the mass ratio of the one-dimensional conductive agent to the fast ion conductor is 0.1:1.

### Embodiment 9

This embodiment is the same as Embodiment 1 except that the weight percent of the one-dimensional conductive agent is 0.3%, the weight percent of the fast ion conductor is 1.5%, that is, the mass ratio of the one-dimensional conductive agent to the fast ion conductor is 0.2:1.

### Embodiment 10

This embodiment is the same as Embodiment 1 except that the weight percent of the one-dimensional conductive agent is 2.25%, the weight percent of the fast ion conductor is 1.5%, that is, the mass ratio of the one-dimensional conductive agent to the fast ion conductor is 1.5:1.

### Embodiment 11

This embodiment is the same as Embodiment 1 except that the weight percent of the one-dimensional conductive agent is 3%, the weight percent of the fast ion conductor is 1.5%, that is, the mass ratio of the one-dimensional conductive agent to the fast ion conductor is 2:1.

### Embodiment 12

This embodiment is the same as Embodiment 1 except that the weight percent of the one-dimensional conductive agent is 1.5%, the weight percent of the fast ion conductor is 0.3%, that is, the mass ratio of the one-dimensional conductive agent to the fast ion conductor is 5:1.

### Embodiment 13

This embodiment is the same as Embodiment 1 except that the weight percent of the one-dimensional conductive agent is 1.5%, the weight percent of the fast ion conductor is 0.75%, that is, the mass ratio of the one-dimensional conductive agent to the fast ion conductor is 2:1.

### Embodiment 14

This embodiment is the same as Embodiment 1 except that the weight percent of the one-dimensional conductive agent is 1.5%, the weight percent of the fast ion conductor is 2.25%, that is, the mass ratio of the one-dimensional conductive agent to the fast ion conductor is 0.67:1.

### Embodiment 15

This embodiment is the same as Embodiment 1 except that the weight percent of the one-dimensional conductive agent is 1.5%, the weight percent of the fast ion conductor is 4.5%, that is, the mass ratio of the one-dimensional conductive agent to the fast ion conductor is 0.33:1.

### Embodiment 16

This embodiment is the same as Embodiment 1 except that the substrate material is lithium iron phosphate (LFP).

### Embodiment 17

This embodiment is the same as Embodiment 1 except that the roasting temperature is 300° C.

### Embodiment 18

This embodiment is the same as Embodiment 1 except that the roasting temperature is 500° C.

### Embodiment 19

This embodiment is the same as Embodiment 1 except that the roasting temperature is 800° C.

### Embodiment 20

This embodiment is the same as Embodiment 1 except that the roasting duration is 8 hours.

### Embodiment 21

This embodiment is the same as Embodiment 1 except that the roasting duration is 20 hours.

### Embodiment 22

This embodiment is the same as Embodiment 1 except that the one-dimensional conductive agent is carbon fiber.

### Embodiment 23

This embodiment is the same as Embodiment 1 except that the fast ion conductor is LGPS.

### Embodiment 24

This embodiment is the same as Embodiment 1 except that the fast ion conductor is Ta-doped Li₇La₃Zr₂O₁₂ (Ta-LLZO), where the doping amount of the Ta element is 0.3 mole.

### Embodiment 25

This embodiment is the same as Embodiment 1 except that the length of the one-dimensional conductive agent is 800 nm, the diameter of the one-dimensional conductive agent is 8 nm, and the length-to-diameter ratio of the one-dimensional conductive agent is 100.

### Embodiment 26

This embodiment is the same as Embodiment 1 except that the length of the one-dimensional conductive agent is 3500 mn, the diameter of the one-dimensional conductive agent is 10 nm, and the length-to-diameter ratio of the one-dimensional conductive agent is 350.

### Embodiment 27

This embodiment is the same as Embodiment 1 except that the length of the one-dimensional conductive agent is 8000 nm, the diameter of the one-dimensional conductive agent is 10 nm, and the length-to-diameter ratio of the one-dimensional conductive agent is 800.

### Embodiment 28

This embodiment is the same as Embodiment 1 except that the length of the one-dimensional conductive agent is 30,000 nm, the diameter of the one-dimensional conductive agent is 15 nm, and the length-to-diameter ratio of the one-dimensional conductive agent is 2000.

### Embodiment 29

This embodiment is the same as Embodiment 1 except that the length of the one-dimensional conductive agent is 50,000 nm, the diameter of the one-dimensional conductive agent is 8 nm, and the length-to-diameter ratio of the one-dimensional conductive agent is 6250.

### Embodiment 30

This embodiment is the same as Embodiment 1 except that the specific surface area of the one-dimensional conductive agent is 25 g/m².

### Embodiment 31

This embodiment is the same as Embodiment 1 except that the specific surface area of the one-dimensional conductive agent is 32 g/m².

### Embodiment 32

This embodiment is the same as Embodiment 1 except that the specific surface area of the one-dimensional conductive agent is 82 g/m².

### Embodiment 33

This embodiment is the same as Embodiment 1 except that the specific surface area of the one-dimensional conductive agent is 176 g/m².

### Embodiment 34

This embodiment is the same as Embodiment 1 except that the specific surface area of the one-dimensional conductive agent is 300 g/m².

### Comparative Embodiment 1

This embodiment is the same as Embodiment 1 except that the process of preparing the positive electrode material is different from that in Embodiment 1.

A process of preparing a positive electrode material is:

Roasting LMFP in an argon atmosphere directly at a temperature of 600° C. for a duration of 15 hours.

### Comparative Embodiment 2

This embodiment is the same as Embodiment 1 except that the process of preparing the positive electrode material is different from that in Embodiment 1.

A process of preparing a positive electrode material is: identical to the preparation process in Embodiment 1 except that LMFP is replaced with LFP.

### Comparative Embodiment 3

This embodiment is the same as Embodiment 1 except that the process of preparing the positive electrode material is different from that in Embodiment 1.

A process of preparing a positive electrode material includes:

grinding CNT, passing it through a 400-mesh sieve, and dispersing the sieved CNT into anhydrous ethanol to obtain a first suspension with a solid content of 50%;

grinding LMFP, passing it through a 400-mesh sieve, and dispersing the sieved LMFP into anhydrous ethanol to obtain a second suspension with a solid content of 50%;

mixing the first suspension and the second suspension evenly to obtain a mixed slurry with a solid content of 50%, and spray-drying the mixed slurry to obtain a positive electrode material precursor, where, based on a total mass of the CNT and the LMFP, the weight percent of the CNT is 1.5%, and the rest is the LMFP; and

roasting the positive electrode material precursor in an argon atmosphere at a temperature of 600° C. for a duration of 15 hours.

The CNT is single-walled, with a length-to-diameter ratio of 1000, a length of 20,000 nm, a diameter of 20 nm, and a specific surface area of 42 g/m². The ion conductivity of the LLZO is 5×10⁻⁴ S/cm.

### Comparative Embodiment 4

This embodiment is the same as Embodiment 1 except that the process of preparing the positive electrode material is different from that in Embodiment 1.

A process of preparing a positive electrode material includes:

grinding LLZO, passing it through a 400-mesh sieve, and dispersing the sieved LLZO into anhydrous ethanol to obtain a first suspension with a solid content of 50%;

grinding LMFP, passing it through a 400-mesh sieve, and dispersing the sieved LMFP into anhydrous ethanol to obtain a second suspension with a solid content of 50%;

mixing the first suspension and the second suspension evenly to obtain a mixed slurry with a solid content of 50%, and spray-drying the mixed slurry to obtain a positive electrode material precursor, where, based on a total mass of the LLZO and the LMFP, the weight percent of the LLZO is 1.5%, and the rest is the LMFP;

roasting the positive electrode material precursor in an argon atmosphere at a temperature of 600° C. for a duration of 15 hours.

The ionic conductivity of the LLZO is 5×10⁴ S/cm.

### Comparative Embodiment 5

This embodiment is the same as Embodiment 1 except that the process of preparing the positive electrode material is different from that in Embodiment 1.

A process of preparing a positive electrode material includes:

grinding LLZO as a fast ion conductor, passing it through a 400-mesh sieve, and dispersing the sieved LLZO into anhydrous ethanol to obtain a first suspension with a solid content of 50%;

grinding LMFP as a substrate material, passing it through a 400-mesh sieve, and dispersing the sieved LMFP into anhydrous ethanol to obtain a second suspension with a solid content of 50%;

mixing the first suspension and the second suspension evenly to obtain a mixed slurry with a solid content of 50%, spray-drying the mixed slurry, and roasting the slurry in an argon atmosphere at a temperature of 600° C. for a duration of 15 hours to obtain a substrate material with a surface to which the fast ion conductor is attached;

grinding CNT as a one-dimensional conductive agent, passing it through a 400-mesh sieve, and dispersing the sieved CNT into anhydrous ethanol to obtain a third suspension with a solid content of 50%;

dispersing, into anhydrous ethanol, the substrate material with a surface to which the fast ion conductor is attached, to obtain a fourth suspension with a solid content of 50%; and

mixing the third suspension and the fourth suspension evenly to obtain a mixed slurry with a solid content of 50%, spray-drying the mixed slurry, and then roasting the slurry under the same roasting conditions. Based on a total mass of the CNT and the LMFP, the weight percent of the CNT is 1.5%, the weight percent of the LLZO is 1.5%, and the rest is the LMFP. The CNT is single-walled, with a length-to-diameter ratio of 1000, a length of 20,000 nm, a diameter of 20 nm, and a specific surface area of 42 g/m². The ion conductivity of the LLZO is 5×10⁻⁴ S/cm.

<Performance Test>

The positive electrode material, the positive electrode plate, and the lithium-ion battery prepared in each embodiment and each comparative embodiment were tested by using the following methods:

SEM and EDS Tests for the Positive Electrode Material

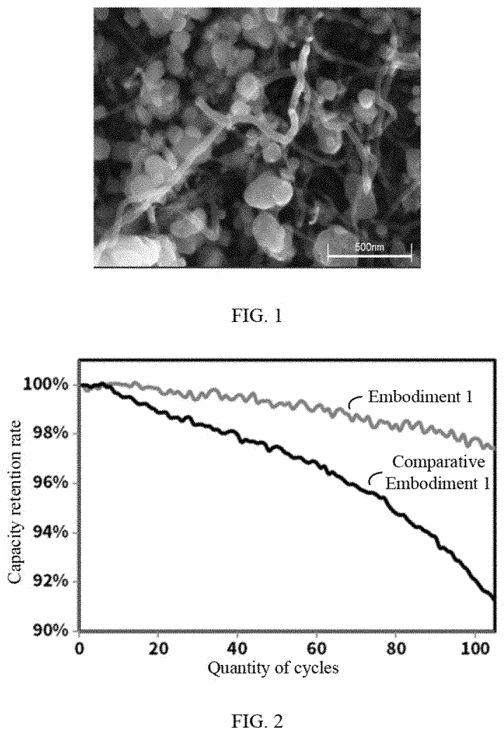

The positive electrode material was made into an electrode plate specimen. The specimen was tested with a scanning electron microscope (SEM) and an energy dispersive spectroscopy (EDS). Secondary information such as secondary electrons, backscattered electrons, and characteristic X-rays was generated on a surface of the specimen as excited by a focused electron beam of the instrument. The secondary information was collected and detected and used to analyze the micro-morphology and micro-region composition on the surface of the specimen. The SEM test result of the positive material in Embodiment 1 is shown in FIG. 1, and the EDS test result is shown in Table 2. SEM and EDS test conditions: working distance: 5 mm to 30 mm; objective lens aperture: 100 μm to 200 μm; acceleration voltage: 2 kV to 20 kV; and test instrument: OXFORD EDS (X-max-20 mm²).

Testing the Resistance of the Positive Active Material Layer of the Positive Electrode Plate

Before testing, end faces of upper and lower terminals of a resistance tester were cleaned by using dust-free paper infiltrated with anhydrous ethanol. The resistance tester (model BER1200) was spot-checked by using a 20.27 mΩ or 0.5 mΩ standard resistor. After the spot check, the resistance tester is reset to zero. During the test, the pressure was greater than or equal to 0.35 T. The positive electrode plate was cut into a size of 60 mm×80 mm for testing resistance. The test method was: placing the cut electrode plate (approximately 60×80 mm) on a pedestal of the instrument, putting on the upper cover board, making the electrode plate cover the test hole as far as possible, putting a specimen carrier that carries the electrode plate into a test cavity, moving the specimen carrier to snap the foremost test hole into a lower terminal, closing the protection door, pressing a pneumatic button in the front of the instrument, and pressing the lower terminal downward to measure the overall resistance and resistivity in the thickness direction of the electrode plate: after the test at one point is completed, moving the specimen carrier to change the test hole; performing the test at intervals of 50 s, taking six sample points on each specimen, and then averaging out the six values. The resistance test of the positive active material layer can effectively evaluate the electronic conductivity of the positive electrode plate and analyze contact resistance on an interface layer of the material.

Testing 0.1C Specific Discharge Capacity

Charge and discharge tests for the lithium-ion battery prepared in each embodiment and each comparative embodiment were performed by using the LAND series battery test system to test the charge and discharge performance of the lithium ion battery. The battery was charged at a constant current of 0.1C rate under a normal temperature until the voltage reached 4.2 V. Further, the battery was charged at a constant voltage of 4.2V until the current was lower than 0.05C, and the battery was left to be in a 4.2 V fully charged state. Then the battery was discharged at a constant-current 0.1C rate until the voltage reached 2.5 V. The obtained capacity is the 0.1C specific discharge capacity. The test results are listed in Table 1, Table 2, and Table 3.

Testing Cycle Performance

The lithium-ion battery prepared in each embodiment and each comparative embodiment was charged and discharged repeatedly according to the following steps, and the discharge capacity retention rate of the lithium-ion battery was calculated.

The lithium-ion battery was charged and discharged for a first time in a 25° C. environment. The battery was charged at a constant current of 0.1C and a constant voltage until the voltage reaches an upper limit of 4.2 V. Then the battery was discharged at a constant current of 1C until the voltage finally reached 2.5 V. The discharge capacity at the end of the first cycle was recorded. Then 100 charge and discharge cycles were performed by repeating the foregoing steps, and the discharge capacity at the end of the 100th cycle was recorded.

Cycle capacity retention rate=(100th-cycle discharge capacity/first-cycle discharge capacity)×100%.

The preparation parameters and test results of the embodiments and comparative embodiments are shown in Table 1, Table 2, and Table 3 below:

TABLE 1
Preparation parameters and test results of embodiments and comparative embodiments

| | | | | | Mass | | | | | | |
|---|---|---|---|---|---|---|---|---|---|---|---|
| | | | | | ratio | | | | | | |
| | | | | | of one- | | | | | | |
| | | | | | dimen- | | | | | | |
| | | | Content | | sional | | | | | | |
| | One- | | of one- | | con- | | | | | | |
| | dimen- | | dimen- | | ductive | | | | | 0.1C | |
| | sional | | sional | Content | agent to | | Roasting | | | specific | Cycle |
| | con- | | con- | of fast | fast ion | Sub- | temp- | Roasting | Roasting | discharge | capacity |
| | ductive | Fast ion | ductive | ion con- | con- | strate | erature | atmos- | duration | capacity | retention |
| | agent | conductor | agent | ductor | ductor | material | (° C.) | phere | (h) | (mAh/g) | rate (%) |
| Embodiment 1 | CNT | LLZO | 1.5% | 1.5% | 1:1 | LMFP | 600 | Argon | 15 | 153 | 96.8 |
| Embodiment 2 | CNT | LLZO | 0.05% | 0.05% | 1:1 | LMFP | 600 | Argon | 15 | 155 | 93.6 |
| Embodiment 3 | CNT | LLZO | 0.1% | 0.1% | 1:1 | LMFP | 600 | Argon | 15 | 155 | 93.8 |
| Embodiment 4 | CNT | LLZO | 0.2% | 0.2% | 1:1 | LMFP | 600 | Argon | 15 | 154 | 95.5 |
| Embodiment 5 | CNT | LLZO | 0.5% | 0.5% | 1:1 | LMFP | 600 | Argon | 15 | 154 | 95.9 |
| Embodiment 6 | CNT | LLZO | 3% | 3% | 1:1 | LMFP | 600 | Argon | 15 | 151 | 98.2 |
| Embodiment 7 | CNT | LLZO | 5% | 5% | 1:1 | LMFP | 600 | Argon | 15 | 149 | 96.6 |
| Embodiment 8 | CNT | LLZO | 0.15% | 1.5% | 0.1:1 | LMFP | 600 | Argon | 15 | 154 | 94.5 |
| Embodiment 9 | CNT | LLZO | 0.3% | 1.5% | 0.2:1 | LMFP | 600 | Argon | 15 | 153 | 95.3 |
| Embodiment 10 | CNT | LLZO | 2.25% | 1.5% | 1.5:1 | LMFP | 600 | Argon | 15 | 152 | 97.1 |
| Embodiment 11 | CNT | LLZO | 3% | 1.5% | 2:1 | LMFP | 600 | Argon | 15 | 151 | 96.2 |
| Embodiment 12 | CNT | LLZO | 1.5% | 0.3% | 5:1 | LMFP | 600 | Argon | 15 | 153 | 94.9 |
| Embodiment 13 | CNT | LLZO | 1.5% | 0.75% | 2:1 | LMFP | 600 | Argon | 15 | 153 | 94.5 |
| Embodiment 14 | CNT | LLZO | 1.5% | 2.25% | 0.67:1 | LMFP | 600 | Argon | 15 | 152 | 96.3 |
| Embodiment 15 | CNT | LLZO | 1.5% | 4.5% | 0.33:1 | LMFP | 600 | Argon | 15 | 150 | 95.3 |
| Embodiment 16 | CNT | LLZO | 1.5% | 1.5% | 1:1 | LFP | 600 | Argon | 15 | 155 | 98.6 |
| Embodiment 17 | CNT | LLZO | 1.5% | 1.5% | 1:1 | LMFP | 300 | Argon | 15 | 154 | 94.6 |
| Embodiment 18 | CNT | LLZO | 1.5% | 1.5% | 1:1 | LMFP | 500 | Argon | 15 | 153 | 96.1 |
| Embodiment 19 | CNT | LLZO | 1.5% | 1.5% | 1:1 | LMFP | 800 | Argon | 15 | 152 | 94.3 |
| Embodiment 20 | CNT | LLZO | 1.5% | 1.5% | 1:1 | LMFP | 600 | Argon | 8 | 153 | 94.2 |
| Embodiment 21 | CNT | LLZO | 1.5% | 1.5% | 1:1 | LMFP | 600 | Argon | 20 | 152 | 95.0 |
| Embodiment 22 | Carbon | LLZO | 1.5% | 1.5% | 1:1 | LMFP | 600 | Argon | 15 | 153 | 97.4 |
| | fiber | | | | | | | | | | |
| Embodiment 23 | CNT | LGPS | 1.5% | 1.5% | 1:1 | LMFP | 600 | Argon | 15 | 152 | 98.1 |
| Embodiment 24 | CNT | Ta-LLZO | 1.5% | 1.5% | 1:1 | LMFP | 600 | Argon | 15 | 153 | 97.8 |
| Comparative | — | — | — | — | — | LMFP | 600 | Argon | 15 | 152 | 92.2 |
| Embodiment 1 | | | | | | | | | | | |
| Comparative | — | — | — | — | — | LFP | 600 | Argon | 15 | 154 | 95.1 |
| Embodiment 2 | | | | | | | | | | | |
| Comparative | CNT | — | 1.5% | 0 | — | LMFP | 600 | Argon | 15 | 152 | 92.9 |
| Embodiment 3 | | | | | | | | | | | |
| Comparative | — | LLZO | 0 | 1.5% | — | LMFP | 600 | Argon | 15 | 152 | 92.4 |
| Embodiment 4 | | | | | | | | | | | |
| Comparative | CNT | LLZO | 1.5% | 1.5% | 1:1 | LMFP | 600 | Argon | 15 | 151 | 93.4 |
| Embodiment 5 | | | | | | | | | | | |

TABLE 2
Preparation parameters and test results of embodiments

| | | | | | Mass | | | | | | | | | |
|---|---|---|---|---|---|---|---|---|---|---|---|---|---|---|
| | | | | | ratio | | | | Length- | | | | | |
| | | | | | of one- | | | Dia- | to-dia- | | | | | |
| | | | | | dimen- | | Length | meter | meter | | | | | |
| | | | Content | | sional | | of one- | of one- | ratio of | | | | | |
| | One- | | of one- | Con- | con- | | dimen- | dimen- | one- | | | | | |
| | dimen- | | dimen- | tent | ductive | | sional | sional | dimen- | Roast- | | | 0.1C | Cycle |
| | sional | Fast | sional | of fast | agent to | Sub- | con- | con- | sional | ing | Roast- | Roast- | specific | capacity |
| | con- | ion | con- | ion | fast ion | strate | ductive | ductive | con- | temp- | ing | ing dur- | discharge | reten- |
| | ductive | con- | ductive | con- | con- | mate- | agent | agent | ductive | erature | atmos- | ation | capacity | tion |
| | agent | ductor | agent | ductor | ductor | rial | (nm) | (nm) | agent | (° C.) | phere | (h) | (mAh/g) | rate (%) |
| Embodi- | CNT | LLZO | 1.5% | 1.5% | 1:1 | LMFP | 20000 | 20 | 1000 | 600 | Argon | 15 | 153 | 96.8 |
| ment 1 | | | | | | | | | | | | | | |
| Embodi- | CNT | LLZO | 1.5% | 1.5% | 1:1 | LMFP | 800 | 8 | 100 | 600 | Argon | 15 | 152 | 94.5 |
| ment 25 | | | | | | | | | | | | | | |
| Embodi- | CNT | LLZO | 1.5% | 1.5% | 1:1 | LMFP | 3500 | 10 | 350 | 600 | Argon | 15 | 152 | 94.9 |
| ment 26 | | | | | | | | | | | | | | |
| Embodi- | CNT | LLZO | 1.5% | 1.5% | 1:1 | LMFP | 8000 | 10 | 800 | 600 | Argon | 15 | 154 | 96.4 |
| ment 27 | | | | | | | | | | | | | | |
| Embodi- | CNT | LLZO | 1.5% | 1.5% | 1:1 | LMFP | 30000 | 15 | 2000 | 600 | Argon | 15 | 156 | 98.1 |
| ment 28 | | | | | | | | | | | | | | |
| Embodi- | CNT | LLZO | 1.5% | 1.5% | 1:1 | LMFP | 50000 | 8 | 6250 | 600 | Argon | 15 | 149 | 97.8 |
| ment 29 | | | | | | | | | | | | | | |

TABLE 3
Preparation parameters and test results of embodiments

| | | | | | Mass | | | | | | | |
|---|---|---|---|---|---|---|---|---|---|---|---|---|
| | | | | | ratio | | Specific | | | | | |
| | | | | | of one- | | surface | | | | | |
| | | | | | dimen- | | area | | | | | |
| | | | Content | | sional | | of one- | | | | | |
| | One- | | of one- | Con- | con- | | dimen- | | | | | |
| | dimen- | | dimen- | tent | ductive | | sional | Roast- | | | 0.1C | Cycle |
| | sional | Fast | sional | of fast | agent to | Sub- | conduc- | ing | Roast- | Roast- | specific | capacity |
| | con- | ion | con- | ion | fast ion | strate | tive | temp- | ing | ing dur- | discharge | reten- |
| | ductive | con- | ductive | con- | con- | mate- | agent | erature | atmos- | ation | capacity | tion |
| | agent | ductor | agent | ductor | ductor | rial | (g/m²) | (° C.) | phere | (h) | (mAh/g) | rate (%) |
| Embodi- | CNT | LLZO | 1.5% | 1.5% | 1:1 | LMFP | 42 | 600 | Argon | 15 | 153 | 96.8 |
| ment 1 | | | | | | | | | | | | |
| Embodi- | CNT | LLZO | 1.5% | 1.5% | 1:1 | LMFP | 25 | 600 | Argon | 15 | 152 | 94.7 |
| ment 30 | | | | | | | | | | | | |
| Embodi- | CNT | LLZO | 1.5% | 1.5% | 1:1 | LMFP | 32 | 600 | Argon | 15 | 152 | 96.6 |
| ment 31 | | | | | | | | | | | | |
| Embodi- | CNT | LLZO | 1.5% | 1.5% | 1:1 | LMFP | 82 | 600 | Argon | 15 | 155 | 98.7 |
| ment 32 | | | | | | | | | | | | |
| Embodi- | CNT | LLZO | 1.5% | 1.5% | 1:1 | LMFP | 176 | 600 | Argon | 15 | 153 | 98.2 |
| ment 33 | | | | | | | | | | | | |
| Embodi- | CNT | LLZO | 1.5% | 1.5% | 1:1 | LMFP | 300 | 600 | Argon | 15 | 157 | 95.1 |
| ment 34 | | | | | | | | | | | | |

TABLE 4
EDS results of positive electrode material in Embodiment 1

| Element | Weight percent (%) | Atom percent (%) |
|---|---|---|
| C | 12.54 | 22.82 |
| O | 30.56 | 49.95 |
| P | 20.32 | 12.97 |
| Mn | 22.56 | 8.07 |
| Fe | 11.39 | 5.42 |
| La | 1.77 | 0.43 |
| Zr | 0.86 | 0.34 |
| Total | 100.00 | 100.00 |

As can be seen from Embodiments 1-15, 17-34, and Comparative Embodiment 1, when the substrate material is LMFP, the cycle capacity retention rate of the lithium-ion battery containing the positive electrode material according to this application is increased.

As can be seen from Embodiment 16 and Comparative Embodiment 2, when the substrate material is LFP, the cycle capacity retention rate of the lithium-ion battery containing the positive electrode material according to this application is increased.

As can be seen from Embodiments 1, 12˜15, 22˜34 and Comparative Embodiment 3, when the content and the roasting conditions of the one-dimensional conductive agent are identical, the cycle capacity retention rate of the lithium-ion battery containing the positive electrode material according to this application is increased, and the 0.1C specific discharge capacity does not change much.

As can be seen from Embodiments 1, 8˜11, 22˜34 and Comparative Embodiment 4, when the content and the roasting conditions of the fast ion conductor are identical, the cycle capacity retention rate of the lithium-ion battery containing the positive electrode material according to this application is increased, and the 0.1C specific discharge capacity basically keeps unchanged.

As can be seen from Embodiments 2˜7, as the content of the one-dimensional conductive agent and the fast ion conductor increases, the cycle performance of the lithium-ion battery is enhanced. However, when the content of the one-dimensional conductive agent and the fast ion conductor increases to some extent, the cycle performance declines a little.

As can be seen from Embodiments 17˜19, the roasting temperature is in the range of 300° C. to 800° C. As the roasting temperature rises, the cycle performance of the lithium-ion battery is enhanced. However, when the temperature rises to some extent, the cycle performance of the lithium-ion battery declines a little. Without being limited to any theory, it is believed that the roasting temperature may affect the bonding between the particles and thereby affect the cycle performance of the lithium-ion battery.

As can be seen from Embodiment 20, Embodiment 21, and Comparative Embodiment 1, the roasting duration exerts some impact on the performance of the positive electrode material. However, on the whole, the cycle capacity retention rate of the lithium-ion battery containing the positive electrode material according to this application is still increased.

As can be seen from Embodiments 22˜23 and Comparative Embodiment 1, other one-dimensional conductive agents such as carbon fiber or other fast ion conductors can also improve the electrochemical performance of the lithium-ion battery. The one-dimensional conductive agent is a long-range conductive agent and can provide sufficient attachment sites for the fast ion conductors. The fast ion conductors can effectively improve the ion conductivity of the material and serve as a protection layer to suppress metal dissolution.

As can be seen from Embodiments 1 and 25˜29, as the length-to-diameter ratio of the one-dimensional conductive agent increases, the cycle performance of the lithium-ion battery is enhanced. However, when the length-to-diameter ratio of the one-dimensional conductive agent increases to some extent, the cycle performance declines a little.

As can be seen from Embodiments 1 and 30˜34, as the specific surface area of the one-dimensional conductive agent increases, the cycle performance of the lithium-ion battery is enhanced. However, when the specific surface area of the one-dimensional conductive agent increases to some extent, the cycle performance declines a little.

As can be seen from Embodiment 1 and Comparative Embodiment 5, both the 0.1C specific discharge capacity and the cycle capacity retention rate in Comparative Embodiment 5 decline. A possible reason is that the LLZO in Comparative Embodiment 5 is directly located on the surface of the substrate material, and thereby leads to increase of the interface resistance and affects the capacity and the cycle performance of the lithium-ion battery.

As can be seen from FIG. 1, in the positive electrode material according to this application, the long-strip-shaped one-dimensional conductive agent is distributed in the substrate material fairly evenly. Small-particle fast ion conductors are attached near the one-dimensional conductive agent, so that the positive electrode material achieves high electronic conductivity and high ionic conductivity.

As can be seen from Table 4, the positive electrode material according to Embodiment 1 of this application contains elements C, O, P, Mn, Fe, La, and Zr.

The foregoing descriptions are merely exemplary embodiments of this application, but are not intended to limit this application. Any modifications, equivalent substitutions, and improvements made within the principles of this application shall fall within the protection scope of this application.

What is claimed is:

1. A positive electrode material, comprising a substrate material, a one-dimensional conductive agent and a fast ion conductor;
wherein,
the one-dimensional conductive agent exists on a surface of the substrate material, and the fast ion conductor exists on a surface of the one-dimensional conductive agent.

2. The positive electrode material according to claim 1, wherein the one-dimensional conductive agent comprises at least one of carbon nanotubes or carbon fiber.

3. The positive electrode material according to claim 1, wherein the fast ion conductor comprises a compound LiₓLa_{y}Zr_{z}MₐO_{b}, wherein 6≤x≤8, 2≤y≤4, 1≤z≤3, 0 ≤a≤0.5, 11≤b≤13, the M element is at least one selected from Ta element or W element.

4. The positive electrode material according to claim 1, wherein the fast ion conductor comprises at least one of Li₇La₃Zr₂O₁₂ or Li₁₀GeP₂S₁₂.

5. The positive electrode material according to claim 1, wherein an ionic conductivity of the fast ion conductor is 1×10⁻⁴ S/cm to 2.7×10⁻² S/cm.

6. The positive electrode material according to claim 1, wherein the substrate material comprises at least one of lithium manganese iron phosphate, lithium iron phosphate, lithium nickel cobalt manganate, lithium nickel cobalt aluminate, lithium manganate, or lithium cobaltate.

7. The positive electrode material according to claim 6, wherein a molar ratio of manganese element to iron element in the lithium manganese iron phosphate is 0.01 to 10.

8. The positive electrode material according to claim 1, wherein, based on a total mass of the positive electrode material, a weight percent of the one-dimensional conductive agent is 0.05% to 5%, and a weight percent of the fast ion conductor is 0.05% to 5%.

9. The positive electrode material according to claim 1, wherein a mass ratio of the one-dimensional conductive agent to the fast ion conductor is 0.1:1 to 10:1.

10. The positive electrode material according to claim 1, wherein a length-to-diameter ratio of the one-dimensional conductive agent is 100 to 6250.

11. The positive electrode material according to claim 1, wherein a length of the one-dimensional conductive agent is 300 nm to 50,000 nm, and a diameter of the one-dimensional conductive agent is 8 nm to 50 nm.

12. The positive electrode material according to claim 2, wherein a specific surface area of the carbon nanotubes is 25 g/m² to 300 g/m².

13. The positive electrode material according to claim 2, wherein the carbon nanotubes comprise at least one of single-walled carbon nanotubes or multi-walled carbon nanotubes.

14. The positive electrode material according to claim 1, wherein the substrate material comprises at least one of ZrO₂, SnO₂, ZnO, MgO, Al₂O₃, TiO₂, CeO₂, AlF₃, or Li₃AlF₆.

15. An electrochemical device, comprising: a positive electrode plate, a negative electrode plater and a separator; the separator is located between the positive electrode plate and the negative electrode plate, the positive electrode plate comprises a positive active material layer and the positive active material layer comprises the positive electrode material;
wherein, the positive electrode material comprising
a substrate material, a one-dimensional conductive agent, and a fast ion conductor;
the one-dimensional conductive agent exists on a surface of the substrate material, and the fast ion conductor exists on a surface of the one-dimensional conductive agent.

16. The electrochemical device according to claim 15, wherein the fast ion conductor comprises a compound LiₓLa_{y}Zr_{z}MₐO_{b}, wherein 6≤x≤8, 2≤y≤4, 1≤z≤3, 0≤a≤0.5, 11≤b≤13, the M element is at least one selected from Ta element or W element.

17. The electrochemical device according to claim 15, wherein the substrate material comprises at least one of lithium manganese iron phosphate, lithium iron phosphate, lithium nickel cobalt manganate, lithium nickel cobalt aluminate, lithium manganate, or lithium cobaltate.

18. The electrochemical device according to claim 17, wherein a molar ratio of manganese element to iron element in the lithium manganese iron phosphate is 0.01 to 10.

19. The electrochemical device according to claim 15, wherein the one-dimensional conductive agent comprises at least one of carbon nanotubes or carbon fiber, a specific surface area of the carbon nanotubes is 25 g/m² to 300 g/m², and, the carbon nanotubes comprise at least one of single-walled carbon nanotubes or multi-walled carbon nanotubes.

20. The electrochemical device according to claim 15, wherein a resistance of the positive active material layer is 0.1 mΩ to 50 mΩ.
